(19) United States
(12) Patent Application Publication
(10) Pub. No.: US 2026/0075687 A1
(43) Pub. Date: Mar. 12, 2026

(54) HEATER ASSEMBLY AND AEROSOL GENERATING DEVICE INCLUDING THE SAME

(71) Applicant: KT&G CORPORATION, Daejeon (KR)

(72) Inventors: Jin Chul JUNG, Daejeon (KR); Jung Ho KIM, Seoul (KR); Sang Cheol PARK, Suwon-si (KR); Jang Won SEO, Yongin-si (KR); Won Kyeong LEE, Guri-si (KR); Chul Ho JANG, Bucheon-si (KR)

(73) Assignee: KT&G CORPORATION, Daejeon (KR)

(21) Appl. No.: 19/269,712

(22) Filed: Jul. 15, 2025

(30) Foreign Application Priority Data
Sep. 12, 2024 (KR) 10-2024-0124919
Dec. 31, 2024 (KR) 10-2024-0202694

(51) Int. Cl. H05B 6/80; A24F 40/46; A24F 40/57; H01P 7/06; H05B 6/68; H05B 6/72

(52) U.S. Cl. CPC H05B 6/80; A24F 40/46; A24F 40/57; H01P 7/06; H05B 6/686; H05B 6/72

(57) ABSTRACT

A heater assembly includes an oscillator configured to generate microwaves, a resonance unit including an insertion space in which an aerosol generating article is accommodated, the resonance unit being configured to heat the aerosol generating article by resonance of the microwaves, and a microwave output unit configured to transmit the microwaves generated in the oscillator to the resonance unit, wherein the microwave output unit is connected to the oscillator and screw-coupled to one region of the resonance unit to couple the oscillator to the resonance unit.

### CROSS-REFERENCE TO RELATED APPLICATIONS

This application is based on and claims priority under 35 U.S.C. § 119 to Korean Patent Application Nos. 10-2024-0124919, filed on Sep. 12, 2024, and 10-2024-0202694, filed on Dec. 31, 2024, in the Korean Intellectual Property Office, the disclosures of which are incorporated by reference herein in their entirety.

### BACKGROUND

### 1. Field

Various embodiments relate to a heater assembly and an aerosol generating device including the same, and more particularly, to a heater assembly in which an oscillator is coupled to a resonance unit through screw coupling, and an aerosol generating device including the heater assembly.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

Among methods of heating an object, microwave heating technology is technology in which water or polar molecules such as an organic solvent may be directly heated by using the principle of dielectric heating. Because microwaves are used to selectively heat only materials that require heating, energy efficiency is high and heating speeds are fast. In the field of aerosol generating devices, continuous studies have also been conducted on microwave heating technology as a new heating method.

### SUMMARY

An aerosol generating device that heats a cigarette (hereinafter, an “aerosol generating article” may be used with a same meaning) by using a microwave heating technology may generally include an oscillator that generates microwaves and a resonance unit that heats the aerosol generating article by resonating the microwaves.

A small error may occur during a process of processing the resonance unit that is a waveguide. Considering such a manufacturing error, it is important to couple the oscillator to the resonance unit so that all resonance units may exhibit a same performance.

At this time, energy may concentrate on a coupled portion between the high-power oscillator and the resonance unit. Therefore, when the oscillator and the resonance unit are coupled together through a method such as soldering, the oscillator may be separated from the resonance unit due to melting caused by high heat. Accordingly, a method is required to easily and precisely control a connection between the oscillator and the resonance unit.

Provided are a heater assembly in which an oscillator is coupled to a resonance unit through screw coupling, and an aerosol generating device including the heater assembly.

Also, provided are a heater assembly in which screw coupling between an oscillator and a resonance unit may be controlled even during a use stage instead of a manufacturing stage, and an aerosol generating device including the heater assembly.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

A heater assembly according to an embodiment may include an oscillator configured to generate microwaves, a resonance unit including an insertion space in which an aerosol generating article is accommodated, the resonance unit being configured to heat the aerosol generating article by resonance of the microwaves, and a microwave output unit configured to transmit the microwaves generated in the oscillator to the resonance unit, wherein the microwave output unit may be connected to the oscillator and screw-coupled to one region of the resonance unit to couple the oscillator to the resonance unit.

An aerosol generating device according to an embodiment may include a heater assembly according to an embodiment, a housing accommodating the heater assembly, a driver configured to move a microwave output unit, and a processor electrically connected to the heater assembly, wherein the processor may be configured to adjust a location of the microwave output unit through a driver such that a frequency of microwaves generated in an oscillator matches a frequency of a resonance unit.

### BRIEF DESCRIPTION OF THE DRAWINGS

The above and other aspects, features, and advantages of certain embodiments will be more apparent from the following description taken in conjunction with the accompanying drawings, in which:

FIG. 1 is a block diagram of an aerosol generating device according to an embodiment;

FIG. 2 is a block diagram of a heater assembly (dielectric heater) and an aerosol generating device including the same, according to an embodiment;

FIG. 3 is a perspective view of an aerosol generating device according to an embodiment;

FIG. 4 is a perspective view of a heater assembly according to an embodiment;

FIG. 5 is a cross-sectional perspective view of the heater assembly of FIG. 4;

FIG. 6 is an enlarged view of a microwave output unit applied to the heater assembly of FIG. 5, and a peripheral portion thereof;

FIG. 7 is an enlarged view of a microwave output unit applied to a heater assembly according to another embodiment, and a peripheral portion thereof; and

FIG. 8 is a cross-sectional view of a heater assembly and an aerosol generating device including the same, according to another embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory) readable by a machine (e.g., an aerosol generating device 1). For example, a processor (e.g., a processor 170) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

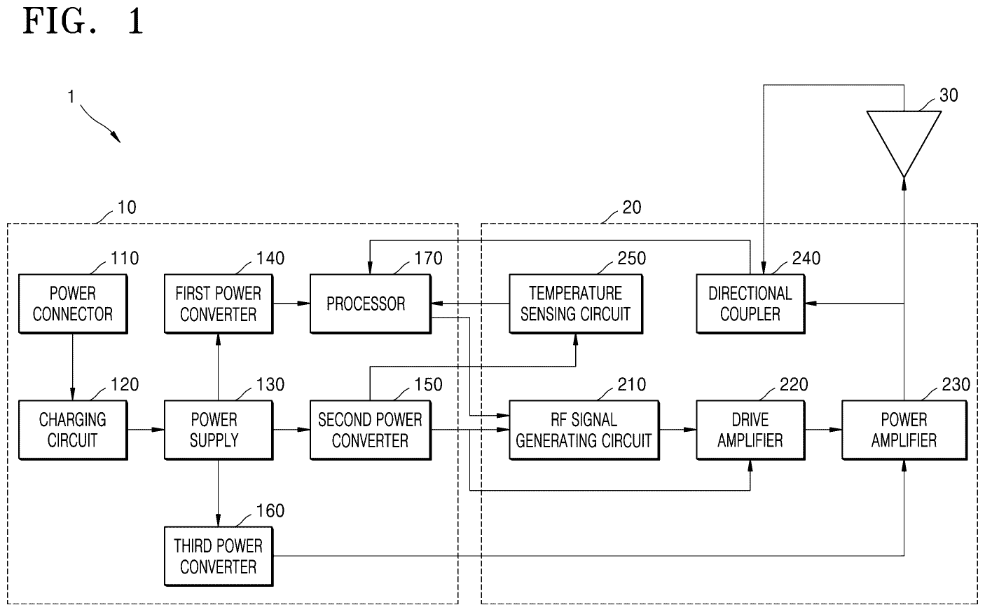

FIG. 1 is a block diagram of an aerosol generating device 1 according to an embodiment.

According to an embodiment, the aerosol generating device 1 may include a control unit 10, a source unit 20, and a radiating unit 30. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 130, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 1 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 130). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 130. The charging circuit 120 may charge the power supply 130 by using power transmitted from the power connector 110. In an example, the charging circuit 120 may be implemented as a charger IC, which is an integrated circuit (IC) that performs functions for efficiently and safely charging the power supply 130. The charging circuit 120 may monitor the charging status of the power supply 130 or optimize the charging process by monitoring the voltage, current, and/or temperature of the power supply 130. For example, the charging circuit 120 may detect the status of the power supply 130 and prevent overcharging or overdischarging by providing an appropriate charging voltage and current.

The power supply 130 may supply power for the operation of the aerosol generating device 1. The power supply 130 may include one or more rechargeable batteries. The power supply 130 may supply power to the radiating unit 30 such that the radiating unit 30 may radiate electromagnetic waves (e.g., RF signals) into the insertion space to heat an aerosol-generating article. Here, power supply to the radiating unit 30 may indicate power supply to the source unit 20. Additionally, the power supply 130 may supply power required for the operation of the processor 170, the RF signal generation circuit 210, the drive amplifier 220, the power amplifier 230, the temperature sensing circuit 250, etc. In an example, the power supply 130 may include, but is not limited to, a lithium polymer (LiPoly) battery. The power supply 130 may be a replaceable type (separated type) battery (hereinafter, a removable battery). The removable battery may be mounted in a battery holder provided within the aerosol generating device 1 or removed from the battery holder. The removable battery may be charged in a wired manner and/or wirelessly.

The aerosol generating device 1 may include a power conversion circuit for converting power supplied from the power supply 130 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V /25 W) suitable for the power amplifier 230.

However, the first power converter 140, the second power converter 150, and the third power converter 160 are not limited to the examples described above and may include other types of power conversion circuits. Additionally, although FIG. 1 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 130 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontroller unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 130 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 1, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g. SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space. For the heating efficiency of the aerosol generating article to be maximized, resonance of electromagnetic waves is to occur within the insertion space. The resonance conditions (e.g., resonant frequency) of the insertion space may vary depending on the amount of dielectric contained in the inserted aerosol-generating article. The processor 170 may control the frequency of an RF signal generated by the RF signal generation circuit 210 to correspond to or be close to the resonance condition of the insertion space by adjusting a control signal input to the RF signal generation circuit 210. The processor 170 may use the directional coupler 240 to obtain information about the resonance conditions of the insertion space.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Since resonance of electromagnetic waves may occur in the insertion space depending on the frequency of the RF signal, the insertion space may be referred to as a resonant section. At least a portion of the insertion space may be surrounded by at least one shielding member to prevent electromagnetic waves from leaking outside the aerosol generating device 1. In an embodiment, the insertion space may further include a physical structure to ensure that the resonance conditions are within a range controllable by the processor 170. The physical structure may include at least one conductor, and the resonance conditions of the insertion space may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that are to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, if the aerosol generating device 1 is a hybrid type device that uses both an aerosol-generating article and a cartridge, the aerosol generating device 1 may further include a cartridge heater. The cartridge heater may receive power from the power supply 130 to heat a medium and/or an aerosol-generating material within the cartridge.

According to an embodiment, the sensor unit may detect the status of the aerosol generating device 1 or the status around the aerosol generating device 1 and transmit the detected information to the processor 170. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol-generating article. The temperature sensor may be positioned in contact with or adjacent to the insertion space or the aerosol-generating article to directly measure the temperature of the insertion space or the aerosol-generating article. Additionally, the temperature sensor may be positioned to be spaced apart from the insertion space or the aerosol-generating article to indirectly measure the temperature of the insertion space or the aerosol-generating article (e.g., in a non-contact manner). In an example, the temperature sensor may include an optical temperature sensor (e.g., an infrared temperature sensor).

In an embodiment, the temperature sensor may detect the temperature of the power supply 130. The temperature sensor may be arranged adjacent to the power supply 130. For example, the temperature sensor may be attached to one surface of the power supply 130 (e.g., a battery) and/or mounted on one surface of a printed circuit board. For example, the aerosol generating device 1 may include a protection circuit module (PCM), and the temperature sensor may be positioned adjacent to the power supply 130 together with the PCM.

According to an embodiment, the temperature sensor may be arranged inside the housing (not shown) of the aerosol generating device 1 to detect the temperature inside the housing (not shown).

In an embodiment, the puff sensor may detect a user's puff.

As an example, the puff sensor may include a pressure sensor. The pressure sensor may output a signal corresponding to the internal pressure of the aerosol generating device 1, and the processor 170 may detect a user's puff based on the signal corresponding to the internal pressure. The internal pressure of the aerosol generating device 1 may correspond to pressure of an airflow path on which gas flows. The puff sensor may be disposed to correspond to the airflow path, through which gas flows, in the aerosol generating device 1.

In another example, the puff sensor may include a temperature sensor. When a user puffs, a temporary temperature drop may occur in the airflow path, the insertion space, the aerosol generating article, etc. The processor 170 may detect the user's puff based on a signal corresponding to the temperature of an airflow path, etc. output from a temperature sensor.

In another example, the puff sensor may include both a pressure sensor and a temperature sensor. In this case, the temperature sensor may measure the temperature which is used to correct the internal pressure measured by the pressure sensor. For example, the puff sensor may correct a signal corresponding to internal pressure based on a temperature measured by the temperature sensor and output the corrected signal. In another example, the puff sensor may output a signal corresponding to a temperature measured by the temperature sensor and a signal corresponding to the internal pressure measured by the puff sensor. In this case, the processor 170 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When a user puffs, temperature changes and/or aerosol flow may occur within the insertion space, thereby changing the permittivity within the insertion space. The processor 170 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of an aerosol-generating article. The insertion detection sensor may be installed around the insertion space.

As an example, the insertion detection sensor may include a capacitive sensor. The capacitive sensor may include at least one conductor, wherein the at least one conductor may be positioned adjacent to the insertion space. When an aerosol generating article is inserted or removed within the insertion space, the permittivity around the conductor may change. The processor 170 may detect insertion and/or removal of an aerosol-generating article based on a signal corresponding to the permittivity inside the insertion space output from the capacitive sensor.

In another example, the insertion detection sensor may include an inductive sensor. The inductive sensor may include at least one coil, wherein the at least one coil may be positioned adjacent to the insertion space. When an aerosol-generating article (e.g., a wrapper for the aerosol-generating article) contains a conductor, a change in the magnetic field may occur around the current-carrying coil when the aerosol-generating article is inserted into or removed from the insertion space. The processor 170 may detect insertion and/or removal of an aerosol-generating article including a conductor based on characteristics of a current output from or detected by an inductive sensor (e.g., frequency of an alternating current, current value, voltage value, inductance value, impedance value, etc.). Alternatively, the aerosol-generating article (e.g., the medium portion of the aerosol-generating article) may include a susceptor (e.g., SUS). Even in this case, a change in the magnetic field around the coil may occur based on the insertion or removal of a susceptor or the like within the insertion space, and the processor 170 may also detect the insertion and/or removal of the aerosol-generating article based on the characteristics of the current of the inductive sensor.

The insertion detection sensor is not limited to the examples described above and may be implemented using various sensors (e.g., proximity sensors, etc.) for detecting insertion and/or removal of an aerosol-generating article. Additionally, the insertion detection sensor may include any combination of the examples described above. In an embodiment, the insertion detection sensor may include a switch or the like for detecting compression by an aerosol-generating article.

In an embodiment, the reuse detection sensor may detect whether an aerosol-generating article has been reused. As an example, the reuse detection sensor may be a color sensor for detecting the color of the aerosol generating article. When the aerosol-generating article is used by a user, a change in color of a portion of the wrapper surrounding the outside of the aerosol-generating article may occur due to the generated aerosol or heating. The color sensor may output a signal corresponding to optical characteristics (e.g., wavelength of light) corresponding to the color of the wrapper based on light reflected from the wrapper. The processor 170 may determine that the aerosol-generating article inserted into the insertion space has already been used if a change in color of a portion of the wrapper is detected.

In an embodiment, the overly moist detection sensor may detect whether the aerosol-generating article is overly moist. For example, the overly moist detection sensor may include a capacitive sensor. The capacitive sensor may include at least one conductor positioned adjacent to the insertion space. The processor 170 may detect whether the aerosol-generating article is overly moist, based on the level of a signal corresponding to a permittivity or the like output from the capacitive sensor. For example, the processor 170 may determine a level range within which the level of the signal is included, based on a look-up table, and determine the moisture content of the aerosol-generating article based on the determined level range.

In an embodiment, the cigarette identification sensor may detect whether the aerosol-generating article is authentic and/or detect the type of the aerosol-generating article.

As an example, the cigarette identification sensor may include an optical sensor for detecting an identification material (or identification tag) located on an outer surface of an aerosol-generating article (e.g., a wrapper). The optical sensor may irradiate light toward the identification material (or identification mark) of the aerosol-generating article and detect, based on the reflected light, the authenticity and/or type of the aerosol-generating article. For example, the identification material may include a material that emits light of a particular wavelength, based on the irradiated light. The processor 170 may detect whether the aerosol-generating article is authentic and/or the type of the article based on the range of the wavelength.

In another example, the cigarette identification sensor may include a capacitive sensor. Depending on the type of aerosol generating article inserted into the insertion space, the permittivity inside the insertion space may vary. The processor 170 may detect whether the aerosol generating article is authentic and/or the type thereof based on a signal corresponding to the permittivity inside the insertion space output from the capacitive sensor.

In another example, the cigarette identification sensor may include an inductive sensor. When a conductor is included in a wrapper and/or interior (e.g., medium portion) of an aerosol-generating article inserted into the insertion space, the characteristics of the current detected by the inductive sensor (e.g., frequency of AC current, current value, voltage value, inductance value, impedance value, etc.) may differ depending on the type of the aerosol-generating article inserted into the insertion space. The processor 170 may detect whether the inserted aerosol-generating article is authentic and/or the type thereof based on the characteristics of the current output from or detected by the inductive sensor.

The cigarette identification sensor is not limited to the examples described above and may be implemented using various sensors to detect whether the aerosol-generating article is authentic and/or to detect the type of the aerosol-generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, the cap detection sensor may detect attachment and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of a cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 170 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

According to an embodiment, the sensor unit may further include, in addition to the sensors described above, at least one of a humidity sensor, an atmospheric pressure sensor, a magnetic sensor, a position sensor (global positioning system (GPS)), or a proximity sensor. The functions of the sensors would be instinctively understood by one of ordinary skill in the art in view of their names and thus detailed descriptions thereof are omitted herein.

According to an embodiment, the output unit may output information about the status of the aerosol generating device 1. The output unit may include, but is not limited to, a display, a haptic unit, and/or an audio output unit. For example, information about the aerosol generating device 1 may include the charging/discharging status of the power supply 130 of the aerosol generating device 1, the operating status of the source unit 20 or the radiating unit 30, the insertion/removal status of the aerosol-generating article and/or cartridge, the mounting and/or removal status of the cap, or the status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. The display, if the display includes a touchpad, may also be used as an input device. The haptic unit may provide tactile information to the user about the status of the aerosol generating device 1. For example, the haptic component may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

According to an embodiment, the input unit may receive information input from a user. For example, the input unit may include a touch panel, a button, a key pad, a dome switch, a jog wheel, a jog switch, and the like.

According to an embodiment, the memory may be hardware that stores various data processed within the aerosol generating device 1, and may store data processed by the processor 170 and data to be processed. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about the operation time of the aerosol generating device 1, the maximum number of puffs, the current number of puffs, at least one temperature profile, and the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near field Communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+ communication unit, a cellular network communication unit, an Internet communication unit, a computer network (e.g., LAN or WAN) communication unit, etc.

According to an embodiment, the processor 170 may control the temperature of the insertion space or the aerosol-generating article by controlling an amplification factor of the source unit 20 (e.g., the power amplifier 230). The processor 170 may control the amplification factor of the source unit 20 (e.g., the power amplifier 230) based on the temperature of the insertion space or the aerosol-generating article detected using the temperature sensor. The processor 170 may control the amplification factor of the source unit 20 (e.g., the power amplifier 230) based on the temperature profile and/or power profile stored in the memory.

Additionally, the processor 170 may control the temperature of the cartridge heater by controlling the supply of power from the power supply 130 to the cartridge heater. The processor 170 may control the temperature of the cartridge heater and/or power supplied to the cartridge heater, based on the temperature of the cartridge heater detected using the temperature sensor. The processor 170 may control the temperature of the cartridge heater and/or the power supplied to the cartridge heater based on the temperature profile and/or power profile stored in the memory.

In an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol-generating article, and/or the cartridge heater exceeds a preset threshold temperature.

According to an embodiment, the processor 170 may control power supply to the source unit 20 or the cartridge heater, based on a result detected by the sensor unit.

In an embodiment, the processor 170 may control power supply to the source unit 20 or the cartridge heater based on insertion and/or removal of the aerosol-generating article into the insertion space. For example, the processor 170 may control power to be supplied to the source unit 20 or the cartridge heater when it is determined that the aerosol-generating article has been inserted into the insertion space using the insertion detection sensor. The processor 170 may cut off the power supply to the source unit 20 or the cartridge heater if it is determined that the aerosol-generating article has been removed from the insertion space using the insertion detection sensor. The processor 170 may determine that the aerosol-generating article has been removed from the insertion space, if the temperature of the insertion space or the aerosol-generating article is above a limited temperature or if the temperature change gradient of the insertion space or the aerosol-generating article is equal to or above a set gradient.

In an embodiment, the processor 170 may control the power supply time and/or power supply amount of power supplied to the source unit 20 or the cartridge heater, based on the state of the aerosol-generating article. For example, the processor 170 may increase the power supply time (e.g., preheating time) of power supply to the source unit 20 or the cartridge heater, if it is determined that the aerosol-generating article is in an overly moist state by using the overly moist detection sensor.

In an embodiment, the processor 170 may control power supply to the source unit 20 or the cartridge heater based on whether the aerosol-generating article is to be reused. For example, the processor 170 may cut off power supply to the source unit 20 or the cartridge heater if it is determined that the aerosol-generating article has been used.

In an embodiment, the processor 170 may control power supply to the source unit 20 or the cartridge heater, based on whether the cartridge is engaged and/or removed. For example, the processor 170 may stop supplying power to the source unit 20 or the cartridge heater or control power not to be supplied to the source unit 20 or the cartridge heater if it is determined, by using the cartridge detection sensor, that the cartridge is removed.

In an embodiment, the processor 170 may control power supply to the source unit 20 or the cartridge heater based on whether the aerosol-generating material in the cartridge has been exhausted. For example, the processor 170 may determine that the aerosol-generating material in the cartridge is exhausted if it is determined that the temperature of the cartridge heater exceeds a limit temperature while preheating the cartridge heater (i.e., during the preheating period). If it is determined that the aerosol-generating material in the cartridge has been exhausted, the processor 170 may cut off the supply of power to the source unit 20 or the cartridge heater.

In an embodiment, the processor 170 may control power supply to the source unit 20 or the cartridge heater based on the availability of the cartridge. For example, the processor 170 may determine that the cartridge is no longer usable if it is determined that the current number of puffs is equal to or greater than the maximum number of puffs set for the cartridge based on data stored in the memory. Alternatively, the processor 170 may determine that the cartridge is unusable if the total time that the cartridge heater has been heated is equal to or greater than a preset maximum time or the total amount of power supplied to the cartridge heater is equal to or greater than a preset maximum amount of power. In this case, the processor 170 may stop supplying power to the source unit 20 or the cartridge heater or control power not to be supplied to the source unit 20 or the cartridge heater.

In an embodiment, the processor 170 may control power supply to the source unit 20 or the cartridge heater based on the user's puff. For example, the processor 170 may use a puff sensor to determine whether a puff has occurred and/or the intensity of the puff. The processor 170 may cut off the power supply to the source unit 20 or the cartridge heater if the number of puffs reaches a preset maximum number of puffs and/or if no puffs are detected for a preset period of time. The processor 170 may also control the supply of power to the source unit 20 or the cartridge heater when a puff is detected.

In an embodiment, the processor 170 may control power supply to the source unit 20 or the cartridge heater based on the authenticity and/or type of the aerosol-generating article (or the cartridge). For example, the processor 170 may use the cigarette identification sensor to detect the authenticity and/or type of the aerosol-generating article (or the cartridge). For example, the processor 170 may cut off power supply to the source unit 20 or the cartridge heater if the aerosol-generating article (or the cartridge) is detected to be counterfeit. The processor 170 may control (e.g., initiate) the supply of power to the source unit 20 or the cartridge heater when the aerosol-generating article (or the cartridge) is detected to be authentic. In another example, the processor 170 may control power supply to the source unit 20 or the cartridge heater differently depending on the type of the aerosol-generating article (or the cartridge). The processor 170 may control the amplification factor of the source unit 20 or the temperature and/or power of the cartridge heater, based on a first temperature profile (or a first power profile) when the aerosol-generating article (or the cartridge) is detected to be a first aerosol-generating article (or a first cartridge), and may control the amplification factor of the source unit 20 or the temperature and/or power of the cartridge heater, based on a second temperature profile (or a second power profile) when the aerosol-generating article (or the cartridge) is detected to be a second aerosol-generating article (or a second cartridge).

According to an embodiment, the processor 170 may control the output unit based on a result detected by the sensor unit. For example, the processor 170 may control the output unit to provide visual, tactile and/or auditory information indicating that the aerosol generating device 1 is about to be terminated, when the number of puffs counted using the puff sensor reaches a preset number. For example, the processor 170 may control the output unit to provide visual, tactile and/or auditory information about the temperature of the insertion space, the aerosol-generating article, or the cartridge heater.

According to an embodiment, the processor 170 may store and update a history of events that occurred in the memory based on the occurrence of a given event. For example, the event may include operations such as detection of insertion of an aerosol-generating article, initiation of heating of an aerosol-generating article, detection of a puff, termination of a puff, detection of overheating, detection of overvoltage application to a cartridge heater, termination of heating of an aerosol-generating article, turning on/off power of the aerosol generating device 1, initiation of charging of the power supply 130, detection of overcharge of the power supply 130, termination of charging of the power supply 130, etc., performed in the aerosol generating device 1. For example, the history of events may include the time an event occurred, log data corresponding to the event, etc. For example, if a given event is detection of insertion of an aerosol-generating article, log data corresponding to the event may include data about sensing values of an insertion detection sensor, etc. For example, if a given event is overheating detection of a cartridge heater, log data corresponding to the event may include data about a temperature of the cartridge heater, a voltage applied to the cartridge heater, a current flowing through the cartridge heater, etc.

According to an embodiment, the processor 170 may control the communication unit to form a communication link with an external device, such as a user's mobile terminal.

According to an embodiment, the processor 170 may release a restriction on the use of at least one function (e.g., a heating function) of the aerosol generating device 1 when data regarding authentication is received from an external device via a communications link. For example, data regarding authentication may include the user's date of birth, a unique number that identifies the user, whether the user has completed authentication, etc.

According to an embodiment, the processor 170 may transmit data about the status of the aerosol generating device 1 to an external device via a communication link (e.g., remaining capacity of the power supply 130, operating mode, etc.). The transmitted data may be output through a display of an external device, etc.

According to an embodiment, when a request for location search of the aerosol generating device 1 is received from an external device via a communication link, the processor 170 may control the output unit to perform an operation corresponding to the location search. For example, the processor 170 may control the haptic unit to generate vibration or control the display to output an object corresponding to the location search and search termination.

According to an embodiment, the processor 170 may perform a firmware update when firmware data is received from an external device via a communication link.

According to an embodiment, the processor 170 may transmit data on sensed values of at least one sensor unit to an external server (not shown) via a communication link, and receive and store a learning model generated by learning the sensed values through machine learning, such as deep learning, from the server. The processor 170 may perform operations such as determining a user's inhalation pattern and generating a temperature profile using a learning model received from a server.

Although not illustrated in FIG. 1, the aerosol generating device 1 may further include a power protection circuit. The power protection circuit may include at least one switching element and may cut off the current path to the power supply 130 in response to overcharge and/or overdischarge of the power supply 130.

An aerosol-generating article as described herein may include at least one aerosol-generating rod (e.g., a medium portion) and at least one filter rod. The radiating unit 30 may be arranged to correspond to at least one aerosol-generating rod, and may be designed differently depending on the arrangement order and/or position of the aerosol-generating rod and the filter rod. The aerosol-generating rod may include at least one of nicotine, an aerosol-generating material, and an additive. For example, the aerosol-generating material may include glycerin (e.g., vegetable glycerin (VG)) and/or propylene glycol (PG), and may also include various other materials. For example, the additive may include flavoring agents and/or organic acids, and may also include various other substances. For example, the aerosol-generating rod may include an aerosol-generating substrate (e.g., a sheet) impregnated with a liquid non-tobacco material (e.g., an aerosol-generating material and/or nicotine), and/or may include a solid tobacco material (e.g., leaf tobacco, reconstituted tobacco, etc.). The tobacco material may be included in the aerosol-generating rod in various forms, such as cut tobacco, granules, or powder. In an embodiment, the additive of the aerosol-generating rod may include a basic substance. Based on the basic material, the nicotine of the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, wherein the two or more aerosol-generating rods may each include tobacco material and/or non-tobacco material. Although not shown, at least one aerosol-generating rod and at least one filter rod may be individually and/or integrally wrapped by at least one wrapper. In the disclosure, the aerosol-generating article may be referred to as a stick.

The cartridge referred to in the disclosure may include an aerosol-generating material having any one of a liquid state, a solid state, a gaseous state, or a gel state therein. The aerosol-generating material may include a liquid composition. For example, the liquid composition may be a liquid including a tobacco-containing material including a volatile tobacco flavor component, or may be a liquid including a non-tobacco material. The cartridge may include a storage portion containing an aerosol-generating material and/or a liquid transfer means impregnated with (containing) the aerosol-generating material. For example, the liquid transfer medium may include a wick such as cotton fibers, ceramic fibers, glass fibers, porous ceramics, etc. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

Hereinafter, an embodiment in which an object to be heated is heated by forming microwaves in a resonant structure through a coupler, rather than by radiating microwaves by using the radiating unit 30 configured as an antenna, will be described.

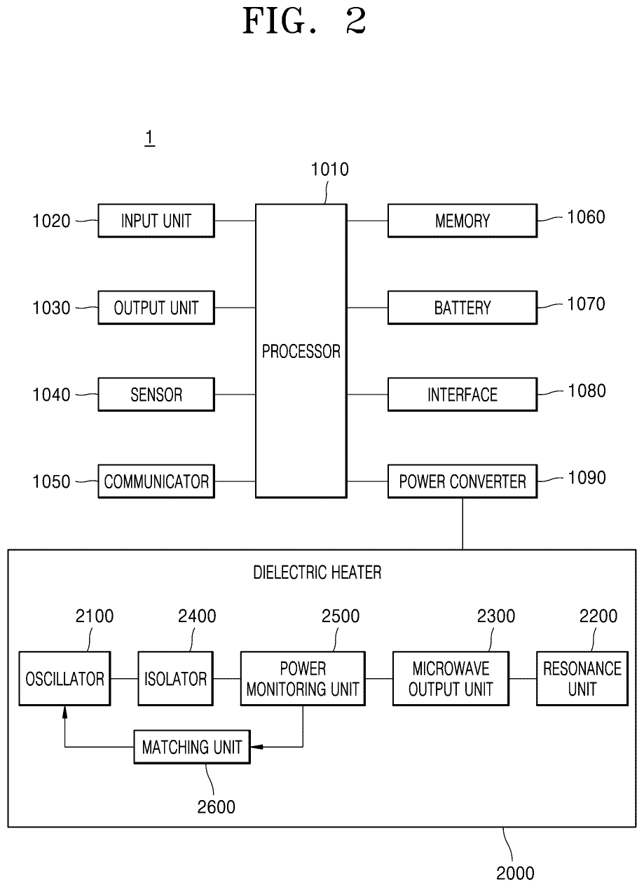

FIG. 2 is a block diagram of a heater assembly (dielectric heater 2000) and the aerosol generating device 1 including the same, according to an embodiment.

Referring to FIG. 2, the aerosol generating device 1 may include an input unit 1020, an output unit 1030, a sensor 1040, a communicator 1050, a memory 1060, a battery 1070, an interface 1080, a power converter 1090, and the dielectric heater 2000. However, an internal structure of the aerosol generating device 1 is not limited to that illustrated in FIG. 2. According to a design of the aerosol generating device 1, some of the components shown in FIG. 2 may be omitted or a new component may be added.

The input unit 1020 may receive a user input. For example, the input unit 1020 may be provided as a single pressing type push button. In another example, the input unit 1020 may be a touch panel including at least one touch sensor. The input unit 1020 may transmit an input signal to a processor 1010. The processor 1010 may supply power to the dielectric heater 2000 based on the user input or output a user notification by controlling the output unit 1030.

The output unit 1030 may output information about a state of the aerosol generating device 1. The output unit 1030 may output information about a charging/discharging state of the battery 1070, a heating state of the dielectric heater 2000, an insertion state of an aerosol generating article, and an error of the aerosol generating device 1. In this regard, the output unit 1030 may include a display, a haptic motor, and a sound output unit.

The sensor 1040 may sense a state of the aerosol generating device 1 or a state around the aerosol generating device 1, and transmit sensed information to the processor 1010. Based on the sensed information, the processor 1010 may control the aerosol generating device 1 to perform various functions, such as controlling heating of the dielectric heater 2000, limiting smoking, determining whether the aerosol generating article has been inserted, displaying a notification, and the like.

The sensor 1040 may include a temperature sensor, a puff sensor, and an insertion detection sensor.

The temperature sensor may detect a temperature inside the dielectric heater 2000 in a non-contact manner or may directly obtain a temperature of a resonator by coming into contact with the dielectric heater 2000. According to an embodiment, the temperature sensor may detect a temperature of the aerosol generating article. Also, the temperature sensor may be arranged adjacent to the battery 1070 to obtain a temperature of the battery 1070. The processor 1010 may control power supplied to the dielectric heater 2000, based on temperature information of the temperature sensor.

The puff sensor may detect a puff of the user. The puff sensor may detect a puff of the user, based on at least one of a temperature change, a flow change, a power change, and a pressure change. The processor 1010 may control power supplied to the dielectric heater 2000, based on puff information of the puff sensor. For example, the processor 1010 may count the number of puffs and block power supplied to the dielectric heater 2000 when the number of puffs reaches a pre-set maximum number of puffs. In another example, the processor 1010 may block power supplied to the dielectric heater 2000 when a puff is not detected for a pre-set period of time or more.

The insertion detection sensor may be arranged inside an insertion space or adjacent to the insertion space to detect insertion or removal of the accommodated aerosol generating article through an insertion hole. For example, the insertion detection sensor may include an inductive sensor and/or a capacitance sensor. The processor 1010 may supply power to the dielectric heater 2000 when the aerosol generating article is inserted into the insertion hole.

According to an embodiment, the sensor 1040 may further include a reuse detection sensor, a motion detection sensor, a humidity sensor, an atmospheric pressure sensor, a magnetic sensor, a cover removal detection sensor, a location sensor (global positioning system (GPS)), and a proximity sensor. Because functions of each sensor may be intuitively inferred by one of ordinary skill in the art from the name, detailed descriptions thereof will be omitted.

The communicator 1050 may include at least one communication module for communication with an external electronic device. The processor 1010 may control the communicator 1050 to transmit information about the aerosol generating device 1 to the external electronic device. Alternatively, the processor 1010 may receive information from the external electronic device through the communicator 1050 to control the components included in the aerosol generating device 1. For example, information transmitted between the communicator 1050 and the external electronic device may include user authentication information, firmware update information, and user smoking pattern information.

The memory 1060 is hardware storing various types of data processed in the aerosol generating device 1, and may store data processed and data to be processed by the processor 1010. For example, the memory 1060 may store an operating time of the aerosol generating device 1, the maximum number of puffs, the current number of puffs, at least one temperature profile, data on the user's smoking pattern, and the like.

The battery 1070 may supply power to the dielectric heater 2000 such that the aerosol generating article may be heated. Also, the battery 1070 may supply power required for operations of other components included in the aerosol generating device 1. The battery 1070 may be a rechargeable battery or a detachable and removable battery.

The interface 1080 may include a connecting terminal that may be physically connected to the external electronic device. For example, the connecting terminal may include at least one or a combination of a high-definition multimedia interface (HDMI) connector, a universal serial bus (USB) connector, a secure digital (SD) card connector, and an audio connector (e.g., a headphone connector). The interface 1080 may transmit or receive information to or from the external electronic device through the connecting terminal, or charge a power supply.

The power converter 1090 may convert direct current power supplied from the battery 1070 into alternating current power. Also, the power converter 1090 may provide the alternating current power to the dielectric heater 2000. The power converter 1090 may be an inverter including at least one switching device and the processor 1010 may control on/off of the switching device included in the power converter 1090 to convert direct current power into alternating current power. The power converter 1090 may be configured as a full-bridge or a half-bridge.

The dielectric heater 2000 may heat the aerosol generating article by using a dielectric heating method. The dielectric heater 2000 may be a component corresponding to a heater assembly 2000 described below.

The dielectric heater 2000 may heat the aerosol generating article by using microwaves and/or an electric field of microwaves (hereinafter, referred to as microwaves or microwave power when distinction is not required).

As described above, a heating method of the dielectric heater 2000 may be a method of heating an object to be heated by forming microwaves in a resonant structure, instead of radiating microwaves by using an antenna.

The dielectric heater 2000 may output microwaves that is a high frequency to a resonance unit 2200. Microwaves may be power in an industrial scientific and medical equipment (ISM) band allowed for heating, but are not limited thereto. The resonance unit 2200 may be designed considering a wavelength of microwaves so that microwaves may resonate in the resonance unit 2200.

The aerosol generating article may be inserted into the resonance unit 2200 and a dielectric material in the aerosol generating article may be heated by the resonance unit 2200. For example, the aerosol generating article may include a polar material and molecules in the polar material may be polarized inside the resonance unit 2200. The molecules may vibrate or rotate according to a polarization phenomenon and the aerosol generating article may be heated by frictional heat generated during such a process. The dielectric heater 2000 will be described in detail below.

The processor 1010 may control general operations of the aerosol generating device 1. The processor 1010 may be implemented in an array of a plurality of logic gates, or in a combination of a general-purpose microprocessor and a memory storing a program executable by the general-purpose microprocessor. The processor 1010 may be implemented in another form of hardware.

The processor 1010 may control direct current power supplied from the battery 1070 to the power converter 1090 or alternating current power supplied from the power converter 1090 to the dielectric heater 2000, according to power demand of the dielectric heater 2000. According to an embodiment, the aerosol generating device 1 may include a converter configured to boost or lower the direct current power, and the processor 1010 may adjust a size of the direct current power by controlling the converter. Also, the processor 1010 may control the alternating current power supplied to the dielectric heater 2000 by adjusting a switching frequency and a duty ratio of the switching device included in the power converter 1090.

The processor 1010 may control a heating temperature of the aerosol generating article by controlling microwave power of the dielectric heater 2000 and a resonating frequency of the dielectric heater 2000. Accordingly, an oscillator 2100, an isolator 2400, a power monitoring unit 2500, and a matching unit 2600 described below may be some components of the processor 1010.

The processor 1010 may control microwave power of the dielectric heater 2000, based on temperature profile information stored in the memory 1060. In other words, a temperature profile may include information about a target temperature of the dielectric heater 2000 according to time, and the processor 1010 may control microwave power of the dielectric heater 2000 according to time.

The processor 1010 may adjust a frequency of microwaves so that the resonating frequency of the dielectric heater 2000 is uniform. The processor 1010 may track, in real time, a change in the resonating frequency of the dielectric heater 2000 according to heating of the object to be heated, and control the dielectric heater 2000 so that a microwave frequency according to the changed resonating frequency is output. In other words, the processor 1010 may change the microwave frequency in real time regardless of the pre-stored temperature profile.

Referring to FIG. 2, the dielectric heater 2000 may include the oscillator 2100, the isolator 2400, the power monitoring unit 2500, the matching unit 2600, a microwave output unit 2300, and the resonance unit 2200. However, an internal configuration of the dielectric heater 2000 is not limited to that shown in FIG. 2. According to a design of the dielectric heater 2000, some of the components shown in FIG. 2 may be omitted or a new component may be added.

The oscillator 2100 may correspond to a same component as a source unit described with reference to FIG. 1 (e.g., the source unit 20 of FIG. 1). The oscillator 2100 may receive alternating current power from the power converter 1090 and generate microwave power of high frequency. According to an embodiment, the power converter 1090 may be included in the oscillator 2100. The microwave power may be selected from frequency bands of 915 MHz, 2.45 GHz, and 5.8 GHz, which are included in ISM bands.

The oscillator 2100 may include a solid-state-based radio frequency (RF) generating apparatus and generate the microwave power by using the same. The solid-state-based RF generating apparatus may be implemented as a semiconductor. When the oscillator 2100 is implemented as a semiconductor, the dielectric heater 2000 may be miniaturized and device lifespan may be increased.

The oscillator 2100 may output the microwave power towards the resonance unit 2200. The oscillator 2100 may include a power amplifier configured to increase or decrease the microwave power and the power amplifier may adjust magnitude of the microwave power according to control by the processor 1010. For example, the power amplifier may decrease or increase amplitude of microwaves. The microwave power may be adjusted by adjusting the amplitude of microwaves.

The processor 1010 may adjust the magnitude of the microwave power output from the oscillator 2100, based on a pre-stored temperature profile. For example, the temperature profile may include information about a target temperature according to a preheating period and a smoking period, and the oscillator 2100 may supply the microwave power of first power during the preheating period and supply the microwave power of second power lower than the first power during the smoking period.

The isolator 2400 may block the microwave power input from the resonance unit 2200 towards the oscillator 2100. The microwave power output by the oscillator 2100 is mostly absorbed by the object to be heated, but part of the microwave power may be reflected at the object to be heated and transmitted back to the oscillator 2100, depending on a heating pattern of the object to be heated. This is because impedance viewed from the oscillator 2100 to the resonance unit 2200 changes according to depletion of polar molecules due to heating of the object to be heated. The meaning that the impedance viewed from the oscillator 2100 to the resonance unit 2200 changes is the same as the meaning that the resonating frequency of the resonance unit 2200 changes. When the microwave power reflected at the resonance unit 2200 is input to the oscillator 2100, not only the oscillator 2100 may malfunction, but also an expected output performance may not be achieved. The isolator 2400 may not return the microwave power reflected at the resonance unit 2200 back to the oscillator 2100, but may induce the microwave power in a certain direction and absorb the same. In this regard, the isolator 240 may include a circulator and a dummy load.

The power monitoring unit 2500 may monitor each of microwave power output from the oscillator 2100 and reflection microwave power reflected at the resonance unit 2200. The power monitoring unit 2500 may transmit, to the matching unit 2600, information about the microwave power and the reflection microwave power.

The matching unit 2600 may match impedance viewed from the oscillator 2100 to the resonance unit 2200 with impedance viewed from the resonance unit 2200 to the oscillator 2100, so that the reflection microwave power is minimized. Impedance matching may have a same meaning as matching a frequency of the oscillator 2100 and the resonating frequency of the resonance unit 2200. Accordingly, to match the impedance, the matching unit 2600 may change a frequency of the oscillator 2100. In other words, the matching unit 2600 may adjust a frequency of the microwave power output from the oscillator 2100 so that the reflection microwave power is minimized. The impedance matching of the matching unit 2600 may be performed in real time regardless of the temperature profile.

The oscillator 2100, the isolator 2400, the power monitoring unit 2500, and the matching unit 2600 are separate components distinguished from the microwave output unit 2300 and the resonance unit 2200 described below, and may be implemented as a microwave source in the form of a chip. Also, according to an embodiment, the oscillator 2100, the isolator 2400, the power monitoring unit 2500, and the matching unit 2600 may be implemented as a partial configuration of the processor 1010.

The microwave output unit 2300 is a component configured to input the microwave power to the resonance unit 2200 and may be referred to as a coupler. The microwave output unit 2300 may be implemented in the form of a SubMiniature Version A (SMA), SubMiniature Version B (SMB), Micro Coaxial (MCX), or Micro-Miniature Coaxial (MMCX) connector. For example, the microwave output unit 2300 may connect the resonance unit 2200 to the microwave source in the form of a chip so as to transmit microwave power generated in the microwave source to the resonance unit 2200.

The resonance unit 2200 may heat the object to be heated by forming microwaves in a resonant structure. The resonance unit 2200 may include the insertion space in which the aerosol generating article is accommodated and the aerosol generating article may be dielectrically heated by being exposed to microwaves. For example, the aerosol generating article may include a polar material and molecules in the polar material may be polarized inside the resonance unit 2200 by microwaves. The molecules may vibrate or rotate according to a polarization phenomenon and the aerosol generating article may be heated by frictional heat generated during such a process.

The resonance unit 2200 includes at least one internal conductor for microwaves to resonate, and the microwaves may resonate inside the resonance unit 2200 according to an arrangement, a thickness, and a length of the internal conductor.

The resonance unit 2200 may be designed considering a wavelength of microwaves so that microwaves may resonate in the resonance unit 2200. For microwaves to resonate inside the resonance unit 2200, the resonance unit 2200 requires a closed end/short end with a closed cross section and an open end with at least one region of the cross section open in a direction opposite to the closed end/short end. A length between the closed end/short end and the open end may be an integer multiple of ¼ of the wavelength of microwaves. The resonance unit 2200 of the disclosure selects a length that is ¼ of the wavelength of microwaves for device miniaturization. In other words, the length of the resonance unit 2200 between the closed end/short end and the open end may be ¼ of the wavelength of microwaves.

The resonance unit 2200 may include a dielectric accommodation space. The dielectric accommodation space is a configuration distinguished from the insertion space of the aerosol generating article, and a material for miniaturizing the resonance unit 2200 by changing an entire resonating frequency of the resonance unit 2200 may be arranged in the dielectric accommodation space. According to an embodiment, the dielectric accommodation space may accommodate a dielectric material having a low degree of microwave absorption. This is to prevent a phenomenon in which the dielectric material self-generates heat when energy to be transmitted to the object to be heated is transmitted to the dielectric material. The degree of microwave absorption may be represented as a loss tangent that is a ratio of an imaginary part to a real part of a complex dielectric constant. According to an embodiment, a dielectric accommodation space may accommodate a dielectric material having a loss tangent equal to or less than a pre-set size, wherein the pre-set size may be 1/100. For example, the dielectric material may be any one or a combination of quartz, tetrafluoroethylene, and an aluminum oxide, but is not limited thereto.

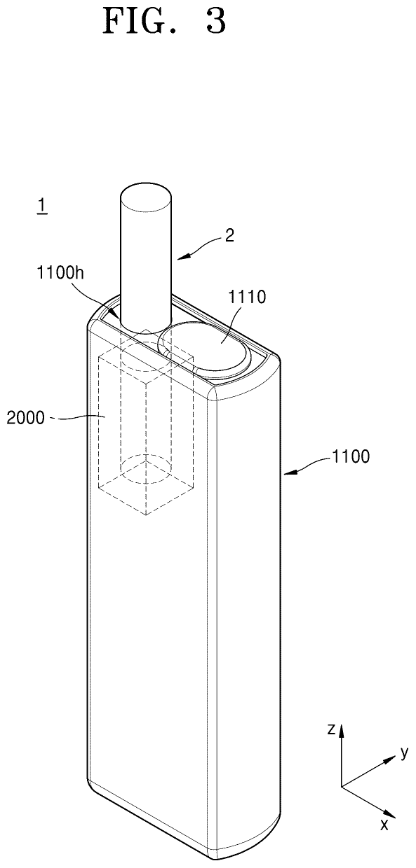

FIG. 3 is a perspective view of the aerosol generating device 1 according to an embodiment.

Referring to FIG. 1, the aerosol generating device 1 according to an embodiment may include a housing 1100 accommodating an aerosol generating article 2, and the heater assembly 2000 configured to heat the aerosol generating article 2 accommodated in the housing 1100.

The housing 1100 may form an overall exterior of the aerosol generating device 1 and components of the aerosol generating device 1 may be arranged in an internal space (or a mounting space) of the housing 1100. For example, the heater assembly 2000, a battery, a processor, and/or a sensor may be arranged in the internal space of the housing 1100, but the components arranged in the internal space are not limited thereto.

An insertion hole 1100h may be formed in one region of the housing 1100, and at least one region of the aerosol generating article 2 may be inserted into the housing 1100 through the insertion hole 1100h. For example, the insertion hole 1100h may be formed in one region of a top surface (e.g., a surface facing a z-axis direction) of the housing 1100, but a location of the insertion hole 1100h is not limited thereto. According to another embodiment, the insertion hole 1100h may be formed in one region of a side surface (e.g., a surface facing an x-axis direction) of the housing 1100.

The heater assembly 2000 is arranged in the internal space of the housing 1100 and heat the aerosol generating article 2 inserted into or accommodated in the housing 1100 through the insertion hole 1100h. The heater assembly 2000 may include an insertion space accommodating the aerosol generating article 2. When the aerosol generating article 2 inserted into or accommodated in the housing 1100 is accommodated in the insertion space of the heater assembly 2000, the heater assembly 2000 may be arranged to surround at least one region of the aerosol generating article 2 and heat the aerosol generating article 2.

According to an embodiment, the heater assembly 2000 may heat the aerosol generating article 2 by using a dielectric heating method. In the disclosure, the dielectric heating method is a method of heating a dielectric material that is an object to be heated by using resonance of microwaves and/or an electric field (or including a magnetic field) of microwaves (hereinafter, referred to as microwaves or microwave power when distinction is not necessary). Microwaves are an energy source for heating the object to be heated and are generated by high-frequency power, and thus, microwaves may be interchangeably used with microwave power. Ultimately, the heater assembly 2000 is a component configured to heat the aerosol generating article 2 accommodated in the insertion space, via microwaves.

Charges or ions of the dielectric material included in the aerosol generating article 2 may vibrate or rotate inside the heater assembly 2000 by microwave resonance, and heat may be generated in the dielectric material by frictional heat generated when the charges or ions vibrate or rotate, and thus, the aerosol generating article 2 may be heated.

When the aerosol generating article 2 is heated by the heater assembly 2000, aerosols may be generated from the aerosol generating article 2. In the disclosure, aerosols may refer to gas particles generated when air and vapor generated as the aerosol generating article 2 is heated are mixed with each other.

The aerosols generated from the aerosol generating article 2 may be discharged to the outside of the aerosol generating device 1 by passing through the aerosol generating article 2 or through an empty space between the aerosol generating article 2 and the insertion hole 1100h. A user may smoke by bringing his/her mouth into contact with one region of the aerosol generating article 2 exposed to the outside of the housing 1100 and inhale the aerosols discharged to the outside of the aerosol generating device 1.

The aerosol generating device 1 according to an embodiment may further include a cover 1110 movably arranged in the housing 1100 to open or close the insertion hole 1100h. For example, the cover 1110 may be slidably combined to the top surface of the housing 1100 to expose the insertion hole 1100h to the outside of the aerosol generating device 1 or cover the insertion hole 1100h so that the insertion hole 1100h is not exposed to the outside of the aerosol generating device 1.

According to an embodiment, the cover 1110 may expose the insertion hole 1100h to the outside of the aerosol generating device 1 at a first location (or an opening location). When the insertion hole 1100h is exposed to the outside, the aerosol generating article 2 may be inserted into the housing 1100 through the insertion hole 1100h.

According to another embodiment, the cover 1110 may cover the insertion hole 1100h at a second location (or a closing location) so that the insertion hole 1100h is not exposed to the outside of the aerosol generating device 1. Here, the cover 1110 may prevent external impurities from entering into the heater assembly 2000 through the insertion hole 1100h when the aerosol generating device 1 is not used.

FIG. 3 illustrates only the aerosol generating device 1 for heating the aerosol generating article 2 in a solid state, but the aerosol generating device 1 is not limited thereto.

An aerosol generating device according to another embodiment may generate aerosols by heating an aerosol generating material in a liquid or gel state, instead of the aerosol generating article 2 in a solid state, through the heater assembly 2000.

An aerosol generating device according to another embodiment may include the heater assembly 2000 configured to heat the aerosol generating article 2, and a cartridge (or a vaporizer) including an aerosol generating material in a liquid or gel state and configured to heat the aerosol generating material. Aerosols generated from the aerosol generating material may move to the aerosol generating article 2 along an airflow passage, through which the cartridge and the aerosol generating article 2 communicate with each other, to be mixed with aerosols generated from the aerosol generating article 2, and then may be transmitted to the user through the aerosol generating article 2.

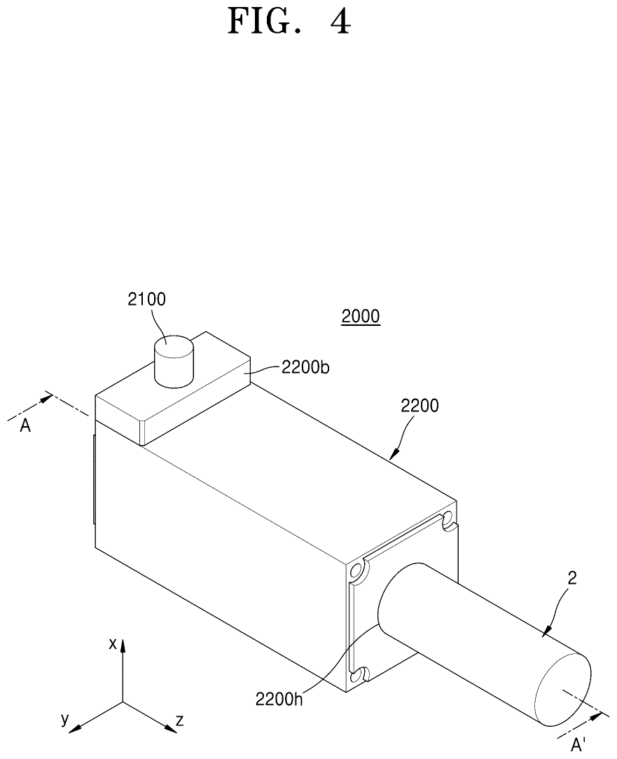

FIG. 4 is a perspective view of the heater assembly 2000 according to an embodiment.

Referring to FIG. 4, the heater assembly 2000 according to an embodiment may include the oscillator 2100 and the resonance unit 2200. The heater assembly 2000 of FIG. 4 may be an embodiment of the heater assembly 2000 and the dielectric heater 2000 described above, and redundant descriptions thereof will be omitted below.

The oscillator 2100 may generate microwaves in a designated frequency band when power is supplied. The microwaves generated in the oscillator 2100 may be transmitted to the resonance unit 2200 through a microwave output unit (not shown) connected to the oscillator 2100. The microwave output unit may be coupled to the resonance unit 2200 through a bracket 2700.

The resonance unit 2200 may include an insertion space 2200h accommodating at least one region of the aerosol generating article 2, and heat the aerosol generating article 2 by using the dielectric heating method by resonating the microwaves generated in the oscillator 2100. For example, charges of glycerin included in the aerosol generating article 2 may vibrate or rotate according to resonance of the microwaves, and heat may be generated in the glycerin according to a frictional heat generated when the charges vibrate or rotate, thereby heating the aerosol generating article 2.

According to an embodiment, the resonance unit 2200 may include a material with a low microwave absorption rate to prevent the resonance unit 2200 from absorbing the microwaves generated in the oscillator 2100.

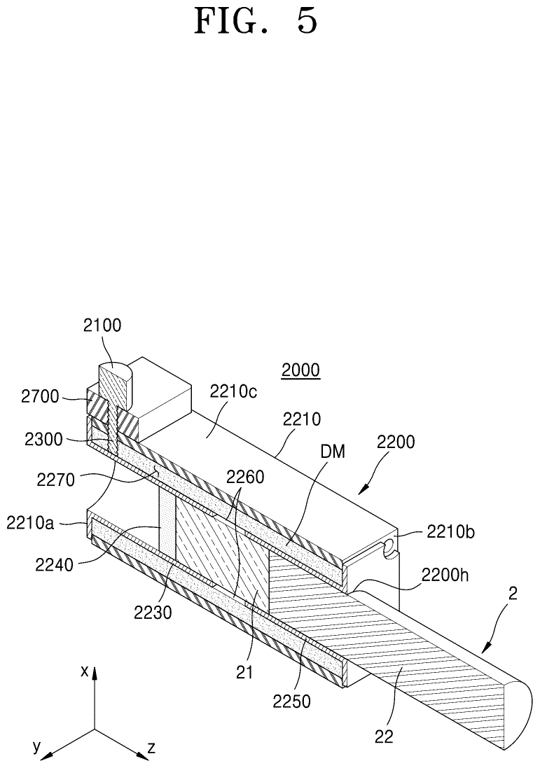

Hereinafter, a specific structure of the resonance unit 2200 of the heater assembly 2000 will be described with reference to FIG. 5.

FIG. 5 is a cross-sectional perspective view of the heater assembly 2000 of FIG. 4.

Referring to FIG. 5, the heater assembly 2000 according to an embodiment may include the oscillator 2100, the resonance unit 2200, and the microwave output unit 2300. Components of the heater assembly 2000 may be the same as or similar to at least one of the components of heater assembly 2000 of FIG. 4, and redundant descriptions will be omitted below.

When an alternating current voltage is applied, the oscillator 2100 may generate microwaves in a designated frequency band, and the microwaves generated in the oscillator 2100 may be transmitted to the resonance unit 2200 through the microwave output unit 2300.

The microwave output unit 2300 is a component configured to transmit the microwaves generated in the oscillator 2100 to the resonance unit 2200. The microwave output unit 2300 may be referred to as a coupler. The microwave output unit 2300 connected to the oscillator 2100 may be coupled to one region of the resonance unit 2200. Accordingly, the microwave output unit 2300 may couple toe oscillator 2100 to the resonance unit 2200.

Here, the microwave output unit 2300 may be coupled to one region of the resonance unit 2200 through screw coupling. The screw coupling may allow one portion of the microwave output unit 2300 coupled to the resonance unit 2200 to be strongly supported without being shaken. Accordingly, the oscillator 2100 connected to the microwave output unit 2300 may be prevented from being shaken or separated from the oscillator 2100 while the aerosol generating device 1 is used.

Also, the screw coupling may allow the microwave output unit 2300 to move along a screw thread with respect to the resonance unit 2200. Accordingly, when a manufacturer adjusts the screw coupling, a location of the microwave output unit 2300 or the oscillator 2100 with respect to the resonance unit 2200 may be adjusted. Also, the manufacturer may adjust the screw coupling to adjust an extent to which the oscillator 2100 is coupled to the resonance unit 2200.

According to an embodiment, the screw coupling may be adjusted not only while manufacturing the heater assembly 2000, but also while the heater assembly 2000 is used. Accordingly, not only the manufacturer, but also the user may adjust the screw coupling to adjust a location or coupling of the microwave output unit 2300 or the oscillator 2100.

As illustrated, a thickness of one region of the resonance unit 2200 to which the microwave output unit 2300 is coupled is relatively less compared to a length of the microwave output unit 2300. In this case, even when the microwave output unit 2300 is screw-coupled to one region of the resonance unit 2200, a portion of the microwave output unit 2300 exposed to the outside of the resonance unit 2200 may be relatively large compared to another portion of the microwave output unit 2300 coupled to the resonance unit 2200. Accordingly, the microwave output unit 2300 may not be firmly fixed to the resonance unit 2200.

According to an embodiment, the heater assembly 2000 may further include the bracket 2700 such that the microwave output unit 2300 is stably coupled to the resonance unit 2200. The portion of the microwave output unit 2300 exposed to the outside of the resonance unit 2200 may be stably coupled to the resonance unit 2200 by being supported by the bracket 2700 protruding in the x-axis direction from one region of the resonance unit 2200.

However, an embodiment is not limited to an arrangement of the bracket 2700. According to an embodiment, the microwave output unit 2300 may be stably coupled to one region of the resonance unit 2200 without the bracket 2700. In this case, a length of the microwave output unit 2300 or a thickness of one region of the resonance unit 2200 to which the microwave output unit 2300 is coupled may be designed to have appropriate values.

Only an embodiment in which the microwave output unit 2300 is fixed to one region of the resonance unit 2200 facing the x-axis direction is illustrated in the drawing, but a location of the microwave output unit 2300 is not limited thereto. According to another embodiment, the microwave output unit 2300 may be fixed to another region of the resonance unit 2200 facing a −z-axis direction.

According to an embodiment, the oscillator 2100 is connected to the microwave output unit 2300 to be coupled on the resonance unit 2200 through the microwave output unit 2300, and thus, the oscillator 2100 is not required to be directly coupled to the resonance unit 2200. Accordingly, a degree of freedom of a shape or form of the oscillator 2100 may improve.

As illustrated, the oscillator 2100 is “directly” connected to the microwave output unit 2300, but according to an embodiment, the oscillator 2100 may be electrically connected to the microwave output unit 2300 through a wire. The oscillator 2100 may be connected to the resonance unit 2200 through the microwave output unit 2300 even when the oscillator 2100 is not arranged adjacent to the resonance unit 2200. Accordingly, a degree of freedom of arrangement of the oscillator 2100 inside the aerosol generating device 1 may improve.

In this case, the oscillator 2100 is not physically coupled to the resonance unit 2200, but the oscillator 2100 may be connected to the resonance unit 2200 and transmit microwaves to the resonance unit 2200. It may be said that the oscillator 2100 is coupled to the resonance unit 2200 even when the oscillator 2100 is connected to the resonance unit 2200 and transmits microwaves to the resonance unit 2200 as such.

In other words, the oscillator 2100 being coupled to the resonance unit 2200 may include not only physical connection, but also electric connection or connection to transmit electromagnetic waves. However, in the disclosure, the expression “the oscillator 2100 is coupled to the resonance unit 2200” will be used based on a meaning that the oscillator 2100 is coupled to the resonance unit 2200 through physical connection.

The resonance unit 2200 is arranged to surround at least one region of the aerosol generating article 2 inserted into the aerosol generating device 1, and may heat the aerosol generating article 2 through microwaves generated in the oscillator 2100. For example, dielectric materials included in the aerosol generating article 2 may generate heat by an electric field generated inside the resonance unit 2200 by microwaves, and the aerosol generating article 2 may be heated by heat generated in the dielectric materials.

According to an embodiment, the aerosol generating article 2 includes a tobacco rod 21 and a filter rod 22.

The tobacco rod 21 includes an aerosol generating material and may be manufactured in sheets or strands or may be manufactured from chopped tobacco sheets. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

At least a portion (e.g., glycerin) of the aerosol generating material included in the aerosol generating article 2 may be a dielectric material having polarity in an electric field, and such at least a portion of the aerosol generating material may generate heat through a dielectric heating method to heat the aerosol generating article 2.

According to an embodiment, the resonance unit 2200 may include an external conductor 2210, a first internal conductor 2230, and a second internal conductor 2250.

The external conductor 2210 may form an overall exterior of the resonance unit 2200 and have a hollow shape such that components of the resonance unit 2200 may be arranged inside the external conductor 2210. The external conductor 2210 may include the insertion space 2200h in which the aerosol generating article 2 is accommodated, and the aerosol generating article 2 may be inserted into the external conductor 2210 through the insertion space 2200h.

According to an embodiment, the external conductor 2210 may include a first surface 2210a, a second surface 2210b facing the first surface 2210a, and a side surface 2210c surrounding an empty space between the first surface 2210a and the second surface 2210b. At least some (e.g., the first internal conductor 2230 and the second internal conductor 2250) of the components of the resonance unit 2200 may be arranged in an internal space of the resonance unit 2200, formed by the first surface 2210a, the second surface 2210b, and the side surface 2210c.

The first internal conductor 2230 may be formed in the shape of a hollow space cylinder extending in a direction from the first surface 2210a of the external conductor 2210 to the internal space of the external conductor 2210.

As illustrated, the microwave output unit 2300 may be screw-coupled to one region of the external conductor 2210 and penetrate the external conductor 2210. Here, one end of the microwave output unit 2300 may be in contact with the oscillator 2100 and the other end of the microwave output unit 2300 may be in contact with one region of the first internal conductor 2230. Accordingly, microwaves generated in the oscillator 2100 may be transmitted to the first internal conductor 2230 through the microwave output unit 2300.

However, an embodiment is not limited to the other end of the microwave output unit 2300 being in contact with one region of the first internal conductor 2230. Because the microwave output unit 2300 is also in contact with the external conductor 2210 through screw coupling, an arrangement structure of the microwave output unit 2300 is not limited thereto as long as microwaves generated in the oscillator 2100 is transmitted to the inside of the resonance unit 2200.

A first region between the external conductor 2210 and the first internal conductor 2230 may operate as a first resonator configured to generate an electric field through resonance of microwaves. The first region may refer to a space formed by the first surface 2210a and the side surface 2210c of the external conductor 2210 and the first internal conductor 2230, and the electric field may be generated inside the first region when microwaves transmitted through the microwave output unit 2300 resonate.

The second internal conductor 2250 may be formed in the shape of a hollow space cylinder extending in a direction from the second surface 2210b of the external conductor 2210 to the internal space of the external conductor 2210. The second internal conductor 2250 may be arranged in the internal space of the external conductor 2210 while being spaced apart from the first internal conductor 2230 by a certain distance, and a gap 2260 may be provided between the first internal conductor 2230 and the second internal conductor 2250.

A second region between the external conductor 2210 and the second internal conductor 2250 may operate as a second resonator configured to generate an electric field through resonance of microwaves. The second internal conductor 2250 may be coupled (e.g., capacitive coupling) to the first internal conductor 2230, and an induced electric field may also be generated in the second region when the electric field is generated in the first region, according to such a coupling relationship. In the disclosure, capacitive coupling may denote a coupling relationship in which energy may be transmitted by capacitance between two conductors.

For example, the electric field may be generated in the first region according to resonance when microwaves generated in the oscillator 2100 is transmitted to the first internal conductor 2230, and the induced electric field may be generated in the second region formed by the external conductor 2210 and the second internal conductor 2250 coupled to the first internal conductor 2230.

According to an embodiment, the first region and the second region of the resonance unit 2200 may operate as a resonator having a length of ¼ wavelength (λ) of microwaves.

For example, one end (e.g., an end in a −z-axis direction) of the first region may be formed as a closed end/short end when a cross section of the first region is closed by the first surface 2210a of the external conductor 2210, and the other end (e.g., an end in the z-axis direction) of the first region may be formed as an open end when the cross section is open because the first surface 2210a is not arranged. In another example, one end (e.g., an end in the −z-axis direction) of the second region may be formed as an open end when a cross section of the second region is open, and the other end (e.g., an end in the z-axis direction) of the second region may be formed as a closed end/short end when the cross section thereof is closed by the second surface 2210b of the external conductor 2210.

In other words, the first region and the second region may be formed in the form of “⊏” in overall by including the closed ends/short ends and the open ends when viewed in a xz plane, and through the above-described structure, the first region and the second region may operate as a resonator having the length of ¼ wavelength of microwaves.

According to an embodiment, the first internal conductor 2230 and the second internal conductor 2250 may have a same length based on a z-axis such that the first region and the second region are symmetrical, but an embodiment is not limited thereto.

The aerosol generating article 2 inserted into the internal space of the external conductor 2210 through the insertion space 2200h may be surrounded by the first internal conductor 2230 and the second internal conductor 2250 and heated via a dielectric heating method.

At least a portion of the electric field generated in the first region and/or the second region by resonance of microwaves may propagate towards the inside of the first internal conductor 2230 and/or the second internal conductor 2250 through the gap 2260 between the first internal conductor 2230 and the second internal conductor 2250, and the aerosol generating article 2 surrounded by the first internal conductor 2230 and the second internal conductor 2250 may be heated by the propagated electric field. For example, the dielectric material included in the aerosol generating article 2 may generate heat by the electric field propagated through the gap 2260 and the aerosol generating article 2 may be heated by heat generated from the dielectric material.

The heater assembly 2000 according to an embodiment may prevent the electric field propagated into the first internal conductor 2230 and/or the second internal conductor 2250 from leaking outside the heater assembly 2000 or the resonance unit 2200 by setting diameters of the first internal conductor 2230 and the second internal conductor 2250 to be less than a designated value. In the disclosure, the designated value may denote a value of a diameter in which the electric field starts to leak outside the first internal conductor 2230 and/or the second internal conductor 2250. For example, when the diameter of the first internal conductor 2230 and/or the second internal conductor 2250 is the designated value or more, some of the electric field introduced into the first internal conductor 2230 and/or the second internal conductor 2250 may leak outside the resonance unit 2200. The heater assembly 2000 according to an embodiment may prevent the electric field from propagating outside the resonance unit 2200 through a structure in which the diameters of the first internal conductor 2230 and the second internal conductor 2250 are less than the designated value, and thereby preventing the electric field from leaking outside the heater assembly 2000 or the resonance unit 2200 without having to use a separate shielding member.

According to an embodiment, when the aerosol generating article 2 is inserted into the resonance unit 2200 through the insertion space 2200h, the tobacco rod 21 of the aerosol generating article 2 may be arranged at a location corresponding to the gap 2260 between the first internal conductor 2230 and the second internal conductor 2250.

When the electric field generated in the first region and the electric field generated in the second region are introduced into the first internal conductor 2230 and/or the second internal conductor 2250 through the gap 2260, a strongest electric field may be generated in a peripheral region of the gap 2260 from among an internal region of the resonance unit 2200. In the heater assembly 2000 according to an embodiment, the tobacco rod 21 including the dielectric material generating heat according to the electric field is arranged at the location corresponding to the gap 2260 where the electric field is the strongest, thereby improving heating efficiency (or dielectric heating efficiency) of the heater assembly 2000.

According to an embodiment, the resonance unit 2200 may further include a closing portion 2240 that is located inside the first internal conductor 2230 and closes a cross section of the first internal conductor 2230 to restrict a flow direction of aerosols generated from the aerosol generating article 2. For example, the closing portion 2240 may close the cross section of the first internal conductor 2230 to block a flow of the aerosols generated from the aerosol generating article 2, in the −z-axis direction.

When the aerosols generated from the aerosol generating article 2 or droplets generated when the aerosols are liquefied flow in the −z-axis direction and are introduced to other components of an aerosol generating device (e.g., the aerosol generating device 1 of FIG. 1), components of the aerosol generating device may malfunction or may be damaged. The heater assembly 2000 according to an embodiment may prevent malfunction of or damage to the components of the aerosol generating device, caused by the aerosols or droplets, by restricting the flow direction of the aerosols by using the closing portion 2240.

According to an embodiment, the resonance unit 2200 may further include the dielectric accommodation space 2270 accommodating a dielectric material DM. The dielectric accommodation space 2270 may be a space between the external conductor 2210, the first internal conductor 2230, and the second internal conductor 2250, and the dielectric material DM with a low degree of microwave absorption may be accommodated in the dielectric accommodation space 2270. For example, the dielectric material DM may be any one or a combination of quartz, tetrafluoroethylene, and an aluminum oxide, but is not limited thereto.

In the heater assembly 2000 according to an embodiment, the dielectric material DM is arranged inside the dielectric accommodation space 2270, and thus, an overall size of the resonance unit 2200 may be reduced and an electric field that is a same level as an electric field generated in a resonance unit not including the dielectric material DM may be generated. In other words, in the heater assembly 2000 according to an embodiment, the size of the resonance unit 2200 may be reduced through the dielectric material DM arranged inside the dielectric accommodation space 2270 to reduce the mounting space of the resonance unit 2200 in the aerosol generating device, and as a result, the aerosol generating device may be miniaturized.

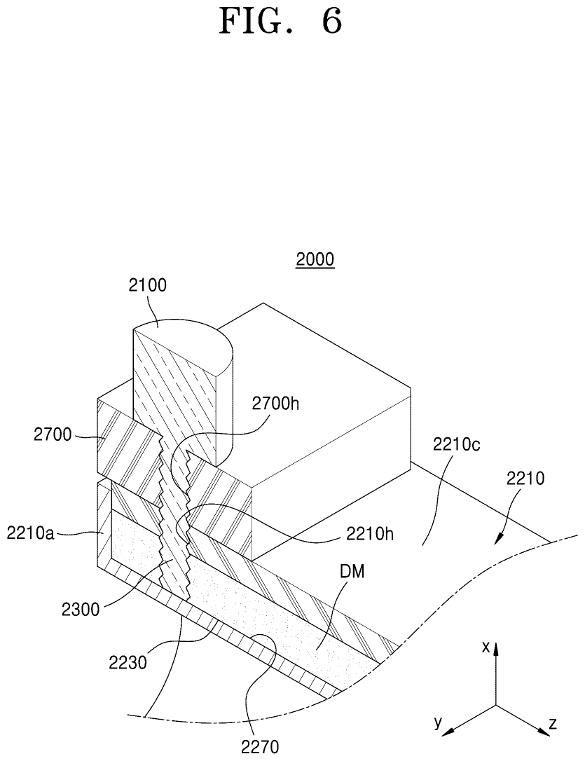

Hereinafter, the microwave output unit 2300 and a surrounding structure thereof will be described in detail with reference to FIG. 6.

FIG. 6 is an enlarged view of the microwave output unit 2300 applied to the heater assembly 2000 of FIG. 5, and a peripheral portion thereof.

Referring to FIG. 6, the heater assembly 2000 according to an embodiment may include the oscillator 2100, the resonance unit 2200, the microwave output unit 2300, and the bracket 2700.

The resonance unit 2200 may include a hole 2210h through which the microwave output unit 2300 passes. The hole 2210h may be arranged in one region of the external conductor 2210. As illustrated, the hole 2210h may be formed on the side surface 2210c of the external conductor 2210. Accordingly, the microwave output unit 2300 may be arranged in a side portion of the resonance unit 2200.

A screw thread to which the microwave output unit 2300 is screw-coupled may be arranged on one region of the resonance unit 2200 or external conductor 2210 surrounding the hole 2210h. The microwave output unit 2300 may be inserted into the resonance unit 2200 by rotating and translating along the screw thread formed on the hole 2210h.

The microwave output unit 2300 may include the shape of a rod extending in a direction in which the hole 2210h is open. Here, one end of the microwave output unit 2300 may be inserted into the resonance unit 2200 through the hole 2210h formed on the external conductor 2210. The other end of the microwave output unit 2300 may be connected to the oscillator 2100.

A location of the one end of the microwave output unit 2300 may be adjusted according to the extent to which the microwave output unit 2300 is inserted into the resonance unit 2200 according to screw coupling. In other words, the location of the one end of the microwave output unit 2300 may be determined when the microwave output unit 2300 rotates and translates along the screw thread formed on the hole 2210h.

The extent to which the oscillator 2100 is coupled to the resonance unit 2200 may vary depending on the location of the one end of the microwave output unit 2300 or the extent to which the microwave output unit 2300 is inserted into the resonance unit 2200.

The extent to which the microwave output unit 2300 is in contact with one region of the resonance unit 2200 (e.g., one region of the external conductor 2210 where the hole 2210h is arranged) may be adjusted when the user adjusts the location of the one end of the microwave output unit 2300 or the extent to which the microwave output unit 2300 is inserted into the resonance unit 2200. This may affect the resonating frequency of the resonance unit 2200. Accordingly, the user may adjust the resonating frequency of the resonance unit 2200 by rotating the microwave output unit 2300 to move along the screw thread.

The external conductor 2210 may perform a function of blocking microwaves output to the inside of the resonance unit 2200 from leaking outside. Here, because the hole 2210h is arranged in the external conductor 2210, it is highly likely that the microwaves may leak through the hole 2210h. However, according to an embodiment, because the screw thread formed on the microwave output unit 2300 is engaged with the screw thread formed on the hole 2210h, a gap through which microwaves may leak may be minimized. In addition, even when there is a small gap between two engaged screw threads, the gap is formed along the shape of the screw threads, and thus, it is not easily for microwaves to leak through the gap having a complex structure.

The bracket 2700 is a component that is coupled to an outer side of the resonance unit 2200 to couple the microwave output unit 2300 to the resonance unit 2200. As illustrated, the bracket 2700 may be arranged on the side surface 2210c of the external conductor 2210. Here, the bracket 2700 may be firmly coupled to the resonance unit 2200. Accordingly, the microwave output unit 2300 supported by the bracket 2700 may also be fixed without moving.

The bracket 2700 may include a hollow space 2700h through which the microwave output unit 2300 passes. The microwave output unit 2300 may penetrate the bracket 2700 by extending in a direction in which the hollow space 2700h is open. Because the bracket 2700 and the resonance unit 2200 are in contact with each other, the microwave output unit 2300 may be coupled to the resonance unit 2200 through the bracket 2700.

The microwave output unit 2300 needs to penetrate the hollow space 2700h of the bracket 2700 and be inserted into the hole 2210h of the external conductor 2210 to be coupled to the resonance unit 2200, and thus, the hollow space 2700h and the hole 2210h may be aligned in a direction (e.g., the x-axis direction) from the outside to the inside of the resonance unit 2200 to be connected to each other.

When the hollow space 2700h and the hole 2210h are aligned, the microwave output unit 2300 having the shape of a rod extending in one direction may pass through the hollow space 2700h and the hole 2210h, which are in contact with each other, at once.

Here, a screw thread to which the microwave output unit 2300 is screw-coupled may be arranged on an inner surface of the bracket 2700 surrounding the hollow space 2700h. When the screw thread arranged on the hole 2210h is referred to as a first screw thread and the screw thread arranged on the hollow space 2700h is referred to as a second screw thread, the microwave output unit 2300 may be inserted into the resonance unit 2200 by being screw-coupled to the second screw thread and the first screw thread sequentially from the outside of the resonance unit 2200.

According to an embodiment, because the microwave output unit 2300 is screw-coupled not only to the resonance unit 2200 but also to the bracket 2700, an entire region of an outer surface of the microwave output unit 2300 may be coupled to and strongly supported by the resonance unit 2200 and the bracket 2700. In other words, owing to the existence of the bracket 2700, the microwave output unit 2300 and the oscillator 2100 connected thereto may be coupled to the resonance unit 2200 without moving or shaking.

However, an embodiment is not limited to the screw thread being arranged on the inner surface of the bracket 2700. According to an embodiment, even when there is no screw thread on the inner surface of the bracket 2700 surrounding the hollow space 2700h, the outer surface of the microwave output unit 2300 may be strongly supported by being in contact with the inner surface of the bracket 2700.

An embodiment is not limited by arrangements of the microwave output unit 2300 and the bracket 2700. The microwave output unit 2300 may be arranged below the resonance unit 2200 (e.g., in the −z-axis direction based on the resonance unit 2200). Also, the microwave output unit 2300 may be directly coupled to the resonance unit 2200 without a separate bracket 2700.

When the microwave output unit 2300 penetrates the external conductor 2210 through the hole 2210h, one end of the microwave output unit 2300 may be located in a space between the external conductor 2210 and the first internal conductor 2230. Because the external conductor 2210 surrounds the first internal conductor 2230 while being spaced apart from the first internal conductor 2230, one end of the microwave output unit 2300 penetrated the external conductor 2210 may move farther by a distance by which the external conductor 2210 is spaced apart from the first internal conductor 2230.

In this case as well, the microwave output unit 2300 may move towards the first internal conductor 2230 by moving along the screw thread arranged in one region of the resonance unit 2200 or the external conductor 2210 surrounding the hole 2210h.

When the external conductor 2210 is a component configured to shield microwaves output into the resonance unit 2200 from leaking outside, the first internal conductor 2230 is a component configured to heat the aerosol generating article 2 by resonating the microwaves.

When one end of the microwave output unit 2300 moved towards the first internal conductor 2230 is in contact with the outer surface of the first internal conductor 2230, the microwave output unit 2300 may directly transmit microwaves to the first internal conductor 2230.

However, even when one end of the microwave output unit 2300 is not in contact with the first internal conductor 2230, the microwave output unit 2300 is coupled to the external conductor 2210 through screw coupling, and thus may transmit microwaves to the external conductor 2210, thereby indirectly transmitting the microwaves to the first internal conductor 2230.

As described above, the resonating frequency of the resonance unit 2200 may vary depending on the extent to which the microwave output unit 2300 is in contact with the resonance unit 2200. As in a case where the resonating frequency of the resonance unit 2200 varies according to the extent to which the microwave output unit 2300 is inserted into the hole 2210h of the external conductor 2210, the resonating frequency of the resonance unit 2200 may also vary depending on whether the microwave output unit 2300 is in contact with the first internal conductor 2230. Accordingly, the user may adjust the resonating frequency of the resonance unit 2200 by rotating the microwave output unit 2300 to move along the screw thread.

According to an embodiment, one end of the microwave output unit 2300, which penetrated the external conductor 2210 and is located between the external conductor 2210 and the first internal conductor 2230, may be in contact with the dielectric material DM accommodated in the dielectric accommodation space 2270. In this case, unlike as illustrated, the dielectric material DM may be filled up to the microwave output unit 2300 inserted into the resonance unit 2200 or up to a portion adjacent to the first surface 2210a of the external conductor 2210.

The dielectric material DM may be arranged so as not to interfere with movement of the microwave output unit 2300 in one direction (e.g., the x-axis direction). Accordingly, the microwave output unit 2300 may come into contact with the first internal conductor 2230 by being inserted between the external conductor 2210 and the first internal conductor 2230 without being interfered by the dielectric material DM. Here, at least a portion of the microwave output unit 2300 inserted into the resonance unit 2200 may be in contact with the dielectric material DM through the outer surface.

The resonating frequency of the resonance unit 2200 may vary depending on the extent to which the microwave output unit 2300 is in contact with the dielectric material DM. The extent to which the microwave output unit 2300 is in contact with the dielectric material DM may vary according to the location of one end of the microwave output unit 2300 present in the dielectric accommodation space 2270 or the extent to which the microwave output unit 2300 is inserted into the resonance unit 2200. Accordingly, the user may adjust the resonating frequency of the resonance unit 2200 by rotating the microwave output unit 2300 to move along the screw thread.

As illustrated, the dielectric material DM is accommodated in an entire region of the dielectric accommodation space 2270 by extending from the first surface 2210a to a second surface (e.g., the second surface 2210b of FIG. 5) of the external conductor 2210, but an embodiment is not limited thereto. According to an embodiment, the dielectric material DM accommodated in the dielectric accommodation space 2270 may not be in contact with the microwave output unit 2300 by being spaced apart from the microwave output unit 2300 in a length direction (e.g., the z-axis direction) of the resonance unit 2200.

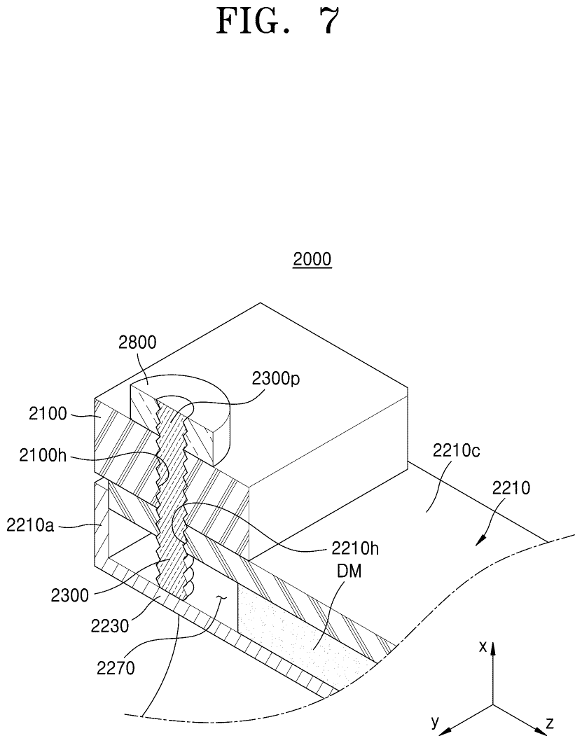

FIG. 7 is an enlarged view of the microwave output unit 2300 applied to the heater assembly 2000 according to another embodiment, and a peripheral portion thereof.

Referring to FIG. 7, the heater assembly 2000 according to another embodiment may include the oscillator 2100, the resonance unit 2200, and the microwave output unit 2300. Detailed descriptions about a configuration and effects of the heater assembly 2000, which overlap those described with reference to FIGS. 5 and 6, will be omitted.

According to another embodiment, the oscillator 2100 may be arranged on the outer surface of the resonance unit 2200. In detail, the oscillator 2100 may be arranged to be in contact with the side surface 2210c of the external conductor 2210 of the resonance unit 2200.

The oscillator 2100 may include a hollow space 2100h through which the microwave output unit 2300 passes. The microwave output unit 2300 may penetrate the oscillator 2100 through the hollow space 2100h.

Here, a screw thread to which the microwave output unit 2300 is screw-coupled may be arranged on an inner surface of the oscillator 2100 surrounding the hollow space 2100h. The microwave output unit 2300 may be inserted into the resonance unit 2200 by being screw-coupled to the screw thread formed on the oscillator 2100 and the screw thread formed on the resonance unit 2200 sequentially from the outside of the resonance unit 2200.

Accordingly, the microwave output unit 2300 is screw-coupled by passing through the oscillator 2100 and the external conductor 2210 at once, and thus, the oscillator 2100 and the resonance unit 2200, which are in contact with each other, may be coupled to each other by the microwave output unit 2300.

The microwave output unit 2300 may include a protruding portion 2300p protruding from the oscillator 2100. For example, one end of the microwave output unit 2300 may be inserted into the resonance unit 2200 and the other end of the microwave output unit 2300 may protrude from the oscillator 2100. Here, the protruding portion 2300p may include the other end of the microwave output unit 2300.

The heater assembly 2000 according to another embodiment may further include a fastening portion 2800 pressing the oscillator 2100 towards the resonance unit 2200 while being screw-coupled to the protruding portion 2300p of the microwave output unit 2300. Here, a relationship between the microwave output unit 2300 and the fastening portion 2800 may be similar to a relationship between a bolt and a nut.

The fastening portion 2800 may come into contact with the oscillator 2100 when the fastening portion 2800 moves towards one end of the microwave output unit 2300 while engaging with the protruding portion 2300p. When the fastening portion 2800 moves towards the resonance unit 2200, the oscillator 2100 may be pressed towards the resonance unit 2200 by the fastening portion 2800. Accordingly, the oscillator 2100 may be firmly coupled to the resonance unit 2200.

Although a separate bracket (e.g., the bracket 2700 of FIG. 6) is not illustrated, an embodiment is not limited thereto. According to an embodiment, a bracket may be arranged between the resonance unit 2200 and the oscillator 2100 or between the oscillator 2100 and the fastening portion 2800.

As described above, the oscillator 2100 may be coupled to the resonance unit 2200 through the microwave output unit 2300 screw-coupled to the resonance unit 2200. This principle is not limited to the resonance unit 2200 and the heater assembly 2000 according to the disclosure. In other words, the principle described above may be applied to a heater assembly of any structure, including an oscillator, a resonance unit, and a microwave output unit.

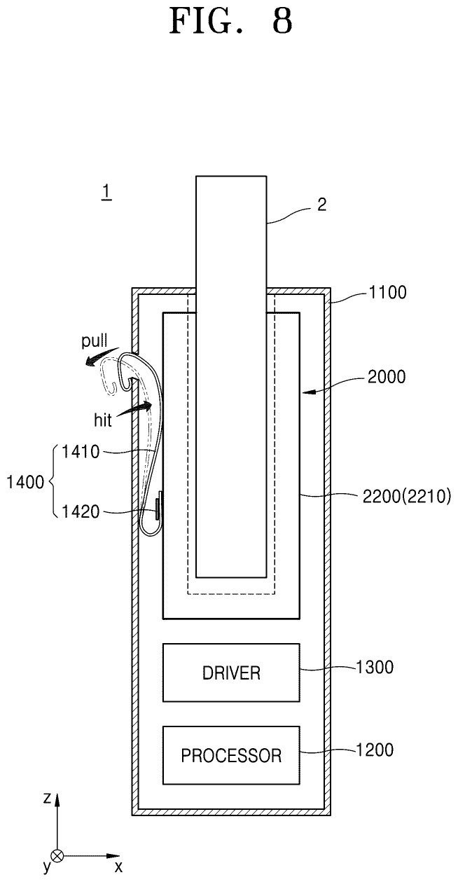

FIG. 8 is a cross-sectional view of the heater assembly 2000 and the aerosol generating device 1 including the same, according to another embodiment.

Referring to FIG. 8, the aerosol generating device 1 according to another embodiment may include the housing 1100, a processor 1200, a driver 1300, and the heater assembly 2000. Detailed descriptions about a configuration and effects of the aerosol generating device 1, which overlap those described above, will be omitted.

The processor 1200 may correspond to a same component as the processor 170 described with reference to FIG. 1 and the processor 1010 described with reference to FIG. 3. The processor 1200 may control internal components such that a frequency of microwaves generated in an oscillator (e.g., the oscillator 2100 of FIG. 5) and the resonating frequency of the resonance unit 2200 match each other.

For example, the processor 1200 may monitor each of microwave power output from the oscillator 2100 through a power monitoring unit (e.g., the power monitoring unit 2500 of FIG. 3) and reflection microwave power reflected from the resonance unit 2200 in a direction of the oscillator 2100.

The processor 1200 may match impedance viewed from the oscillator 2100 towards the resonance unit 2200 with impedance viewed from the resonance unit 2200 towards the oscillator 2100 such that the reflection microwave power is minimized through a matching unit (e.g., the matching unit 2600 of FIG. 3). Impedance matching may have a same meaning as matching the frequency of the oscillator 2100 and the resonating frequency of the resonance unit 2200.

The processor 1200 may match the impedance by changing the frequency of the oscillator 2100 through the matching unit 2600. Accordingly, the frequency of the microwave power output from the oscillator 2100 may be adjusted such that the reflection microwave power is minimized. Here, the impedance matching through the matching unit 2600 may be performed whenever power is supplied to the aerosol generating device 1 again when power is blocked.

In other words, the processor 1200 may match the frequency of the oscillator 2100 with the resonating frequency of the resonance unit 2200 whenever the user reboots the aerosol generating device 1 or turns on, again, the aerosol generating device 1 that is turned off, thereby maintaining a heating performance of the heater assembly 2000 in an optimum state.

The frequency of the oscillator 2100 is an electronically set value, and the resonating frequency of the resonance unit 2200 is a mechanically set value. In other words, the frequency of the oscillator 2100 may be adjusted in an electronical manner, and the resonating frequency of the resonance unit 2200 may be adjusted in a mechanical manner.

As described above, the user may control the frequency of the microwaves generated in the oscillator 2100 to match the resonating frequency of the resonance unit 2200 by using the processor 1200, in an electronical control manner. On the other hand, the user may control the resonating frequency of the resonance unit 2200 to match the frequency of the microwaves generated in the oscillator 2100 in a mechanical control manner.

In other words, when the above descriptions were about adjusting the frequency of the oscillator 2100 to the resonating frequency of the resonance unit 2200, descriptions about adjusting the resonating frequency of the resonance unit 2200 to the frequency of the oscillator 2100 will now be described.

According to another embodiment, the resonating frequency of the resonance unit 2200 may change depending on the extent to which a microwave output unit (e.g., the microwave output unit 2300 of FIG. 5) is inserted into the resonance unit 2200.

As described above, the extent to which the microwave output unit 2300 is inserted into the resonance unit 2200 may be adjusted by the manufacturer during a manufacturing process or by the user during a usage process. However, to operate the heater assembly 2000 in this regard, the aerosol generating device 1 needs to be disassembled.

However, when there is a component capable of causing mechanical movement in the aerosol generating device 1, the user may control the component through the processor 1200 to move the microwave output unit 2300 without having to disassemble the aerosol generating device 1.

The aerosol generating device 1 according to another embodiment may include the driver 1300 electrically connected to the processor 1200. The driver 1300 is a component for moving a microwave output unit (e.g., the microwave output unit 2300 of FIG. 5). The driver 1300 may include one or more actuators. The actuator may include various components that perform mechanical work using electricity, hydraulics, compressed air, and the like. For example, the actuator may include a motor. The actuator may perform linear movement as well as rotary movement, allowing a component connected to the actuator to rotate and/or move linearly.

According to another embodiment, the driver 1300 may rotate or translate the microwave output unit 2300 along the screw thread to which the microwave output unit 2300 is engaged. Accordingly, the driver 1300 may adjust the resonating frequency of the resonance unit 2200 by adjusting the extent to which the microwave output unit 2300 is inserted into the resonance unit 2200.

The user may control the driver 1300 through the processor 1200 in an electronical control manner. As described above, the processor 1200 monitors each of the microwave power output from the oscillator 2100 and the reflection microwave power reflected from the resonance unit 2200, and when it is determined that the frequency of the oscillator 2100 and the resonating frequency of the resonance unit 2200 do not match each other based thereon, adjust the resonating frequency of the resonance unit 2200 by controlling the driver 1300.

In detail, the processor 1200 may match the resonating frequency of the resonance unit 2200 to the frequency of the oscillator 2100 by adjusting the location of the microwave output unit 2300 through the driver 1300 such that the frequency of the microwaves generated in the oscillator 2100 matches the frequency of the resonance unit 2200.

According to the above description, to determine the resonating frequency of the resonance unit 2200, the processor 1200 may perform power monitoring through the power monitoring unit 2500. When the above method is an electronical method for determining the resonating frequency of the resonance unit 2200, the resonating frequency of the resonance unit 2200 may also be determined through a mechanical method.

The aerosol generating device 1 according to another embodiment may further include a vibration generator 1400 configured to generate vibration in the resonance unit 2200 of the heater assembly 2000. The vibration generator 1400 may apply an impact on the resonance unit 2200 according to an operation of the user.

In detail, the vibration generator 1400 may include a hitting member 1410 and a fixing member 1420. One end portion of the hitting member 1410 may be coupled to the external conductor 2210 of the resonance unit 2200 through the fixing member 1420. Another end portion of the hitting member 1410 may be exposed to the outside of the housing 1100 through an open portion of the housing 1100. The other end portion of the hitting member 1410 may be in contact with the external conductor 2210.

The hitting member 1410 may include an elastic material. As a result, the hitting member 1410 may function as a plate spring having one end portion fixed by the fixing member 1420.

The other end portion of the hitting member 1410 and a hitting portion may come into contact with the external conductor 2210 when no operation is applied to the hitting member 1410. Then, when the user pulls the other end portion of the hitting member 1410 downward and releases the same, the hitting member 1410 moved away from the external conductor 2210 may move towards the external conductor 2210 by an elastic restoring force.

At this time, because the one end portion of the hitting member 1410 is fixed to the external conductor 2210 by the fixing member 1420, a remaining portion of the hitting member 1410 may move towards the external conductor 2210 with the one end portion of the hitting member 1410 as a center of rotation. Accordingly, the hitting portion of the hitting member 1410 may apply an impact on the external conductor 2210, and thus, the resonance unit 2200 may vibrate.

The processor 1200 may determine the frequency of the resonance unit 2200 based on a frequency of vibration generated in the resonance unit 2200 by the vibration generator 1400. When the frequency of the oscillator 2100 and the resonating frequency of the resonance unit 2200 do not match each other, the processor 1200 may adjust the location of the microwave output unit 2300 through the driver 1300 such that the frequency of the microwaves generated in the oscillator 2100 and the frequency of the resonance unit 2200 match each other, thereby matching the resonating frequency of the resonance unit 2200 to the frequency of the oscillator 2100.

The processor 1200 matches the resonating frequency of the resonance unit 2200 to the frequency of the oscillator 2100 in such a manner, thereby maintaining the heating performance of the heater assembly 2000 to an optimum state.

According to a heater assembly and an aerosol generating device including the same, according to embodiments, a same heating performance may be achieved despite of a physical deviation of a resonance unit for each heater assembly.

Also, according to a heater assembly and an aerosol generating device including the same, according to embodiments, a heating performance may be easily adjusted by user not only during a manufacturing stage but also during a use stage.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to a heater assembly and an aerosol generating device including the same, according to embodiments, a same heating performance may be achieved despite of a physical deviation of a resonance unit for each heater assembly.

Also, according to a heater assembly and an aerosol generating device including the same, according to embodiments, a heating performance may be easily adjusted by user not only during a manufacturing stage but also during a use stage.

Effects of the present disclosure are not limited to the above effects, and effects that are not mentioned could be clearly understood by one of ordinary skill in the art from the present specification and the attached drawings.

What is claimed is:

1. A heater assembly comprising:
an oscillator configured to generate microwaves;
a resonance unit including an insertion space in which an aerosol generating article is accommodated, the resonance unit being configured to heat the aerosol generating article by resonance of the microwaves; and
a microwave output unit configured to transmit the microwaves generated in the oscillator to the resonance unit,
wherein the microwave output unit is connected to the oscillator and screw-coupled to one region of the resonance unit to couple the oscillator to the resonance unit.

2. The heater assembly of claim 1, wherein the resonance unit comprises a hole through which the microwave output unit passes, and
a screw thread to which the microwave output unit is screw-coupled is arranged in one region of the resonance unit surrounding the hole.

3. The heater assembly of claim 2, wherein the microwave output unit comprises a shape of a rod extending in a direction in which the hole is open, and
one end of the microwave output unit is inserted into the resonance unit.

4. The heater assembly of claim 3, wherein a location of the one end of the microwave output unit is adjustable according to an extent to which the microwave output unit is inserted into the resonance unit by screw coupling.

5. The heater assembly of claim 3, wherein another end of the microwave output unit is connected to the oscillator.

6. The heater assembly of claim 3, wherein the oscillator is arranged on an outer surface of the resonance unit and
the microwave output unit penetrates through the oscillator.

7. The heater assembly of claim 6, wherein the oscillator comprises a hollow space through which the microwave output unit passes,
a screw thread to which the microwave output unit is screw-coupled is arranged on an inner surface of the oscillator surrounding the hollow space, and
the microwave output unit is inserted into the resonance unit by being screw-coupled to a screw thread of the oscillator and a screw thread of the resonance unit sequentially from an outside of the resonance unit.

8. The heater assembly of claim 6, wherein the microwave output unit comprises a protruding portion that protrudes from the oscillator, and
the heater assembly further comprises a coupling member screw-coupled to the protruding portion of the microwave output unit and pressing the oscillator towards the resonance unit.

9. The heater assembly of claim 1, further comprising a bracket comprising a hollow space through which the microwave output unit passes, the bracket being coupled to an outside of the resonance unit to couple the microwave output unit to the resonance unit,
wherein the microwave output unit extends in a direction in which the hollow space is open, while passing through the bracket and being coupled to the resonance unit.

10. The heater assembly of claim 9, wherein the resonance unit comprises a hole through which the microwave output unit passes, and
the hollow space is aligned with the hole.

11. The heater assembly of claim 10, wherein a first screw thread to which the microwave output unit is screw-coupled is arranged in one region of the resonance unit surrounding the hole,
a second screw thread to which the microwave output unit is screw-coupled is arranged on an inner surface of the bracket surrounding the hollow space, and
the microwave output unit is inserted into the resonance unit by being screw-coupled to the second screw thread and the first screw thread sequentially from an outside of the resonance unit.

12. The heater assembly of claim 2, wherein the resonance unit comprises: an internal conductor configured to resonate the microwaves to heat the aerosol generating article; and an external conductor spaced apart from the internal conductor, surrounding the internal conductor, and including the hole, and
the microwave output unit is movable towards the internal conductor by moving along the screw thread arranged in one region of the resonance unit surrounding the hole.

13. The heater assembly of claim 12, further comprising a dielectric accommodation space between the external conductor and the internal conductor,
wherein at least a portion of the microwave output unit inserted into the resonance unit is capable of coming into contact with a dielectric material accommodated in the dielectric accommodation space.

14. An aerosol generating device comprising:
the heater assembly of claim 1;
a housing accommodating the heater assembly;
a driver configured to move the microwave output unit; and
a processor electrically connected to the heater assembly,
wherein the processor is configured to adjust a location of the microwave output unit through the driver such that a frequency of the microwaves generated in the oscillator matches a frequency of the resonance unit.

15. The aerosol generating device of claim 14, further comprising a vibration generator configured to generate vibration in the resonance unit,
wherein the processor is further configured to: determine the frequency of the resonance unit, based on a frequency of the vibration generated in the resonance unit by the vibration generator; and adjust the location of the microwave output unit through the driver such that the frequency of the microwaves generated in the oscillator matches the frequency of the resonance unit.
